(19) United States
(12) Patent Application Publication
(10) Pub. No.: US 2016/0345769 A1
(43) Pub. Date: Dec. 1, 2016

(54) Method for Mixing a Powder with a Liquid, and Capsule and Mixing Device for Carrying Out Said Method

(71) Applicant: NOOTRIE AG, Zürich (CH)

(72) Inventors: Clemens Maurice CLAUSEN, Zurich (CH); Marcel DELAVY, Zurich (CH); Hans Peter STOCKER, Zurich (CH)

(21) Appl. No.: 15/100,631

(22) PCT Filed: Oct. 1, 2014
(86) PCT No.: PCT/EP2014/002671

§ 371 Date: May 31, 2016

(30) Foreign Application Priority Data
Oct. 1, 2013 (CH) 01692/13

(51) Int. Cl. A47J 31/36; B01F 11/00; B65D 85/804; B01F 3/12; A47J 31/40; A47J 31/44

(52) U.S. Cl. CPC A47J 31/3695; A47J 31/407; A47J 31/4403; B65D 85/8043; B01F 3/1242; B01F 11/0008; B01F 11/0031; B01F 2215/0022

(57) ABSTRACT

The invention relates to a method for producing a mixed drink, wherein a capsule (22) enclosing a powder-filled volume (27) is inserted into a receptacle of a mixing device, and is opened by closing a lid of the receptacle, and as a result, a cover film (26) of the capsule (22) is pierced by several hollow needles (12, 14). To this end, pressure is exerted thereon by means of a punch (9), which causes the piercing of a closure film (25) above an outlet (24) via mixing rods (32) and via skewers (29) arranged in the volume (27). Water is then injected through a portion of the hollow needles (12), and the mixture is discharged through the outlet (24). After a pause or introduction of air under positive pressure by means of a further hollow needle (14), water is injected again, and finally, air is introduced once again. During the entire process, the receptacle is put into a vibration by an electric motor via an eccentric pin, the frequency of which is about 42 Hz, and the amplitude of which is about 1.5 mm, and which is transmitted onto the capsule (22). The result is an intensive mixing of the powder with the water.

### FIELD OF THE INVENTION

The present invention relates to a method for mixing a powder with a liquid, usually water. The invention further relates to a capsule containing the powder and a mixing apparatus adapted to carry out the method. A preferred area of application of the present invention is the preparation of beverages.

### STATE OF THE ART

WO 2012/174 331 A1 discloses a method and a mixing apparatus of the generic type. The capsule is subjected to vibration with a frequency ranging between 10 Hz and 200 kHz. Specific examples given are frequencies of 22 kHz, as well as 20 Hz and 100 Hz. High frequencies have however proven to be energetically unfavorable. Much of the energy is absorbed by the container of the capsule, where it can lead to heating and softening of the material. In the mixing material itself the damping is high, which makes it impossible to achieve a thorough mixing of the whole material in a short time. But also in the low frequencies given, i.e. 20 Hz and 100 Hz, the powder is only incompletely solved in the liquid.

WO 2013/127 696 A1 shows a method wherein, pressurized gas is introduced into the capsule after the liquid, and a mixing apparatus adapted for the method. Apparently the capsule is not subjected to any vibration.

From CN 2013 987311 U another method of the generic type is known, wherein the frequency of the vibration lies in the ultrasound range. As mentioned above, high frequencies have however not proven favorable.

### DETAILED DISCLOSURE OF THE INVENTION

It is an object of the invention to set forth a method of the generic type, wherein a thorough mixing of the powder and the liquid is achieved with only low energy consumption. This object is achieved by the invention as characterised in the claims.

With the method according to the invention, a total mixing and homogenization occurs after a short time. Energy consumption is low. Disturbing effects such as damage to the capsule are not to be expected. It has shown that the quality of mixing, in particular the proportion of the powder solved in the liquid, is sensitive to and dependent from the frequency of the vibration, and that the quality of mixing and solving of the powders that are usually processed is particularly high in the range selected according to the invention, so that at most only very little residues of the unsolved powder will remain in the capsule.

According to the invention, a capsule is also set forth which is particularly suitable for the method according to the invention. In addition, a mixing apparatus is described that is adapted to carry out said method in an efficient and safe manner.

### SHORT DESCRIPTION OF THE DRAWINGS

In the following, the invention will be discussed with reference to the figures, which show only one exemplary embodiment. In the figures

FIG. 1 shows a mounting and a vibration generator of a mixing apparatus according to the invention in perspective, wherein parts of a housing have been indicated,

FIG. 2 shows a vertical section through the mounting and the vibration generator of FIG. 1,

FIG. 3 shows a vertical section through a capsule according to the invention, and

FIG. 4 shows a vertical section through the capsule of FIG. 3 and a part of the closed lid of the mounting.

### WAYS OF CARRYING OUT THE INVENTION

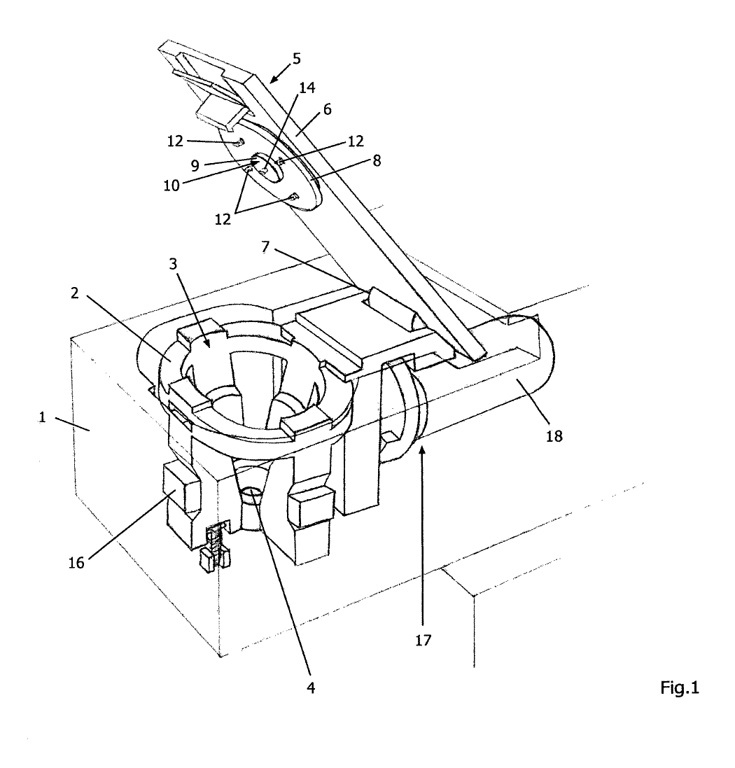

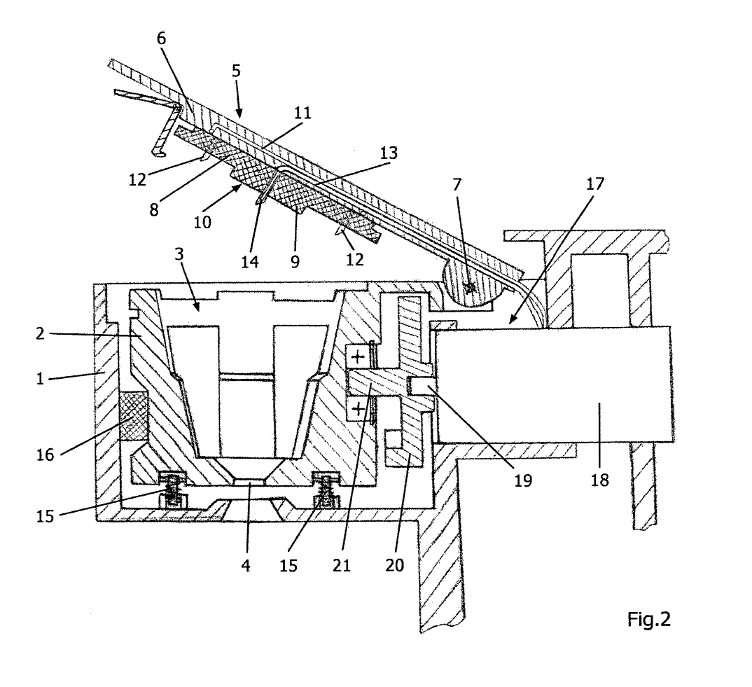

The part of a mixing apparatus according to the invention shown in FIGS. 1 and 2 comprises, in a housing 1, a mounting 2 that forms a receptacle 3 for a capsule that conically tapers downwardly from a round opening on the upper side of the mounting 2. On the bottom of the receptacle 3, a drainage opening 4 is arranged that is narrowing in its upper part in the shape of a funnel, the drainage opening aligning with a corresponding opening in a wall of the housing thereunder that widens downwardly.

The mounting 2 carries a lid 5 with a flap 6 that is pivotable about a horizontal axle 7 from an open to a closed horizontal position. On the underside of the flap 6, a round seal 8 made of a not too soft elastic material is arranged, with a central punch 9 that protrudes into the receptacle 3 when the lid 5 is closed, and forms a pressure surface 10 facing towards the bottom of the receptacle. Several liquid lines 11—for example two or, as shown in the figures, four—that start at a tank (not shown) in the housing 1 and terminate in hollow needles 12 surrounding the punch 9 pass through the flap 6. In addition, an air line 13 passes through the flap 6 and connects an air pump (not shown) arranged in the housing 1 with a hollow needle 14 that is centrally passed through the punch 9 and protrudes from the pressure surface 10.

The mounting 2 is resiliently suspended in the housing 1. To that end, it is supported on four pins 15 surrounded by coil springs, the pins being guided in a vertically displaceable manner in sleeves mounted on the housing 1. A cushion element 16 made of elastic material is clamped between the mounting 2 and a wall of the housing 1, and is bonded to the wall.

A vibration generator 17 comprises an electric motor 18 mounted to the housing 1 and having an output axle 19 connected to the mounting 2 via a coupling element configured as an unbalance disk 20. In order to engage with the mounting 2, the unbalance disk 20 has an eccentric pin 21 parallel to the output axle 19 but offset relative thereto, the pin being rotatably supported on the outside of the mounting 2. The electric motor 18 preferably has a rotational speed of between 2000 rpm and 3000 rpm. 2500 rpm has proven to be a particularly favorable value. The offset of the eccentric pin 21 relative to the output axle 19 can range between 0.5 mm and 2 mm, and is preferably 1.5 mm. When the electric motor 18 runs at nominal speed, a vibration with a frequency ranging between 33 Hz and 50 Hz is forced onto the mounting 2. Frequencies in a range from 40 Hz to 45 Hz, for example 41.7 Hz corresponding to a rotational speed of 2500 rpm, have proven particularly useful in that the proportion of the powder that was completely resolved was the highest, in particular even for hardly soluble powders with high protein content. The amplitude of the vibration will roughly correspond to the offset of the eccentric pin 21 and thus ranges between 0.5 mm and 2 mm accordingly, and is preferably larger than 1 mm. Particularly good results have been achieved with an amplitude of 1.5 mm.

The mounting 2 follows the circular motion of the eccentric pin 21, i.e. it vibrates both in the horizontal direction transverse to the direction of the output axle 19, as well as in the vertical direction. Alternatively, the vertical vibration may be suppressed in that the eccentric pin engages in a vertical slot on the mounting 2, and in that the latter is suspended in a way that it can only perform a horizontal motion. It is however also possible to use a vibration generator that only generates a horizontal motion in the first place, e.g. with an electric motor that is configured as a linear motor. Alternatively, an electric motor with a vertical output axle can be used. In that case, a planar vibratory movement that can be linear, or elliptical, depending on the support and connection with the output axle, will again be forced onto the capsule.

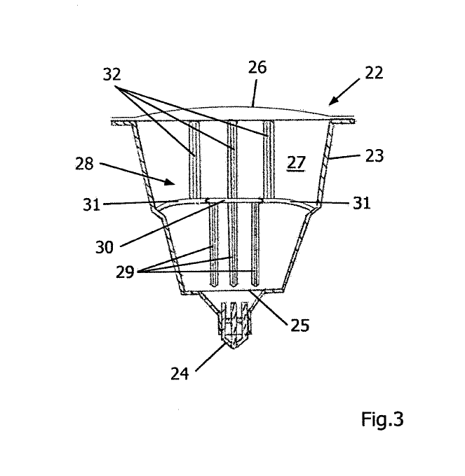

The capsule 22 shown in FIG. 3 has a container 23 comprising a vertical outer wall that is approximately rotationally symmetrical about a vertical axis and slightly tapering downwardly, and an outlet 24 having multiple parallel microchannels on the lower end thereof. Above the outlet 24 is a round drainage opening with a tight closure formed by a closure film 25. The container 23 is closed off on an upper side by a lid that is slightly bent out upwardly and consists of a cover film 26. The container 23 is made of a rigid material, preferably plastics, and the closure film 25 and the cover film 26 are preferably made of plastics foil, in particular of polyethylene foil, or aluminum foil. The container 23 surrounds a volume 27 that is completely or partly filled with a powder (not shown).

Also arranged in the volume 27 is an opening device 28 having several skewers 29 with tips directed against the closure film 25, but spaced apart therefrom by about 4 to 8 mm, e.g. 6 mm. They are respectively arranged on a bottom side of a ring 30 that is supported on or connected to the container 23 by several straight or curved identical spokes that are evenly distributed along its circumference. The outer ends of the spokes 31 may be connected to an outer ring resting on a circumferential ledge of the container 23 that extends roughly at about medium height. Several mixing rods 32 of the opening device 28 protrude upwards into the vicinity of the cover film 26. They are preferably arranged on upper sides of spokes 31, as shown here, or possibly on an upper side of the inner ring 30.

The inner ring 30, the spokes 31 and if present the outer ring form a carrier supported on the container 23, to which both the skewers 29 as well as the mixing rods 32 are attached. In each case the mixing rods 32 are operatively connected to the skewers 29 in such a way that in case of a downward movement of the mixing rods 32 the skewers 29 are taken along with them. The opening device 28 thus provides an overall operative connection between the lid and the closure, through which the skewers 29 are pressed against the closure film 25 and penetrate it, i.e. the closure film 25 is perforated and the capsule 22 is opened on its underside, when the cover film 26 is bent downwards by the pressure acting on it from above.

The opening device 28 can be formed as a single piece and may be made of plastics, e.g. by injection molding.

In the context of the method according to the invention, it is possible to process powders with widely varying characteristics, wherein the focus lies on the preparation of beverages. The powder material may consist of proteins, tonics, soluble food fibers, fruit powders, mineral salts, flavorings and the like. The powders can have widely varying particle sizes; the powder might be very fine, or rather coarse, or even be a coarsely crystalline powder. The consistency can also vary widely and range from dry to flocculent or creamy. The mixture could then be a fruit or vegetable drink, soy milk, or a vitamin, diet or strength-building drink.

In the following, a typical sequence of the method for preparing a beverage will be described.

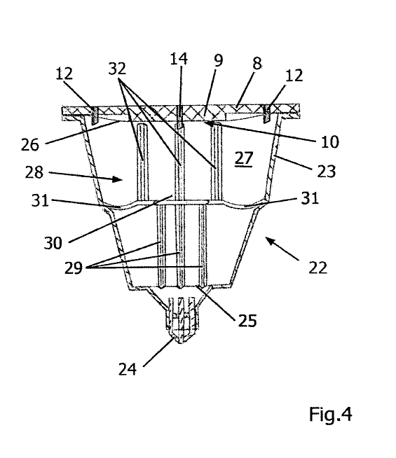

First, a capsule 22 filled with powder is inserted into the receptacle 3. Its outer wall rests in substantial parts against the wall of the receptacle 3. Then the lid 5 is closed by pivoting the flap 6 into a horizontal closing position (FIG. 4) where it snaps shut with the housing 1. With this movement, the pressure surface 10 of the punch 9 touches the cover film 26 of the capsule 22 and presses it against the upper ends of the mixing rods 32, which in turn press the skewers 29 with further downward movement of the flap 6 against the closure film 25 so as to pierce it. At the same time, the hollow needles 12 and 14 pierce the cover film 26.

Then the electric motor 18 is switched on and rapidly reaches its nominal speed of e.g. 2,500 rpm, thereby setting the mounting 2 in into vibration with a frequency of 41.7 Hz, which is then also transferred onto the container. This is followed by a first mixing process, wherein 75 ml of water are injected through the hollow needles 12 with a pressure of between 2 bar and 5 bar. This takes about 10 to 18 seconds. By means of the vibration and the positive pressure in the volume 27, the holes pierced into the closure film 25 by the skewers 29 are widened and the film is indented downwardly in such a way that the holes become at least in part free and a mixture of powder and water can flow out through the outlet already during the introduction of water. Subsequently, between 200 ml and 300 ml of air with a positive pressure of about 0.5 bar is introduced through the hollow needle 14. This will take about 6 to 9 seconds. Through this introduction of air following the mixing process, the part of the mixture that has not been drained is expelled.

The mixing process is then repeated, and subsequently air is again introduced under positive pressure. Finally, the electric motor 18 is switched off. The lid 5 can then be opened and the capsule 22 can be removed from the receptacle 3. Thus the mixing is effected very thoroughly and in relatively short time. Almost no residues remain in the volume 27 enclosed by the capsule 22. It has been shown that the opening device 28, above all the mixing rods 32, also enhances the mixing and noticeably shortens the mixing times.

Depending on the circumstances, such as the properties of the powder and the size of the capsule, a single mixing process might suffice, or alternatively two, as described herein, or more mixing processes could be required. After each mixing process air can be introduced under positive pressure, or just a short pause could be interposed. In particular after the last mixing process, the introduction of pressurized air is advisable, so that the capsule may be emptied virtually completely in most cases.

### LIST OF REFERENCES

1 Housing
2 Mounting
3 Receptacle
4 Drainage opening
5 Lid
6 Flap
7 Axle
8 Seal
9 Punch
10 Pressure surface
11 Liquid line
12 Hollow needle
13 Air line
14 Hollow needle
15 Pins
16 Cushion element
17 Vibration generator
18 Electric motor
19 Output axle
20 Unbalance disk
21 Eccentric pin
22 Capsule
23 Container
24 Outlet
25 Closure film
26 Cover film
27 Volume
28 Opening device
29 Skewers
30 Inner ring
31 Spokes
32 Mixing rods

1. A method for mixing a powder with a liquid, wherein the powder is contained in a closed capsule and is mixed with the liquid by opening the capsule, introducing liquid into the same and putting the capsule into vibration, and wherein the mixture is discharged therefrom, characterized in that the vibration has a frequency ranging between 33 Hz and 50 Hz.

2. The method according to claim 1, characterized in that the frequency of the vibration ranges between 40 Hz and 45 Hz.

3. The method according to claim 1, characterized in that the amplitude of the vibration that the capsule is subjected to ranges between 0.5 mm and 2 mm and is preferably larger than 1 mm.

4. The method according to claim 1, characterized in that the capsule is pierced open on an upper side, and is also opened on an underside.

5. The method according to claim 1, characterized in that a mixing process is effected after the opening of the capsule, wherein on the upper side liquid is injected under pressure, while a mixture of powder and liquid is drained from the capsule on an underside thereof.

6. The method according to claim 5, characterized in that the mixing process is repeated at least once, wherein a pause is interposed or air is introduced under positive pressure between subsequent mixing processes, respectively.

7. The method according to claim 5, characterized in that at least after the last mixing process air is introduced under positive pressure.

8. A capsule for mixing a powder with a liquid, with a container made of rigid material surrounding a volume for receiving a powder, the container having an opening on an upper side that is closed off by a lid made of flexible material, characterized in that it comprises an opening device through which the capsule is opened on an underside when the lid is pressed down.

9. The capsule according to claim 8, characterized in that it has an outlet on the underside, and a discharge opening arranged above it as well as a closure for it that can be perforated by the opening device.

10. The capsule according to claim 8, characterized in that the opening device is arranged in the volume and has at least one skewer with a tip facing towards the closure, the skewer being operatively connected to the lid so that it presses against the closure and opens it when the lid is sufficiently deflected downwardly.

11. The capsule according to claim 10, characterized in that the operative connection between the lid and the at least one skewer is effected by at least one mixing rod arranged in the volume, connected to the skewer and extending at least into the vicinity of the lid.

12. The capsule according to claim 11, characterized in that both the at least one skewer and the at least one mixing rod are arranged on a carrier that is connected to the container.

13. The capsule according to claim 12, characterized in that the carrier comprises a plurality of flexible spokes that protrude into the volume from outer ends connected to the container.

14. The capsule according to claim 13, characterized in that it comprises a ring that is connected to the spokes.

15. The capsule according to claim 14, characterized in that the at least one skewer is connected to an underside of the ring, and the at least one mixing rod is connected to an upper side of one of the spokes or of the ring.

16. A mixing apparatus for executing the method according to claim 1, with a mounting forming a receptacle for the capsule, and with a vibration generator operatively connected to the mounting in such a way that it can put the same into vibration, characterized in that the vibration generator is adapted to generate a vibration with a frequency ranging between 33 Hz and 50 Hz.

17. The mixing apparatus according to claim 16, characterized in that the vibration generator is adapted to generate a vibration with a frequency ranging between 40 Hz and 45 Hz.

18. The mixing apparatus according to claim 16, characterized in that it comprises a lid that is adapted to close off the receptacle and that carries at least one hollow needle for feeding the liquid, the hollow needle protruding into the receptacle when the lid is closed.

19. The mixing apparatus according to claim 18, characterized in that the lid carries at least one further hollow needle for the introduction of pressurized air, the needle also protruding into the receptacle when the lid is closed.

20. The mixing apparatus according to claim 18, characterized in that the lid comprises a punch with a pressure surface the punch protruding into the receptacle when the lid is closed.

21-24. (canceled)
